(19) United States
(12) Patent Application Publication
(10) Pub. No.: US 2015/0282627 A1
(43) Pub. Date: Oct. 8, 2015

(54) SUN SHIELD WITH SOLAR POWERED LIGHT

(71) Applicant: Mark Z. Gjelaj, Stamford, CT (US)

(72) Inventor: Mark Z. Gjelaj, Stamford, CT (US)

(21) Appl. No.: 14/243,033

(22) Filed: Apr. 2, 2014

(51) Int. Cl. A47C 7/72; F21S 9/03; A47C 7/66

(52) U.S. Cl. CPC A47C 7/725; A47C 7/66; F21S 9/037

(57) ABSTRACT

A dual function visor that replaceably attaches to a back of a chair or the like, shields overhead sun from a user sitting in the chair or the like, and provides illumination for the user sitting in the chair or the like. The dual function visor includes a frame and a shade. The frame replaceably attaches to the back of the chair or the like. The shade is pivotally attached to the frame, shields the overhead sun from the user sitting in the chair or the like, and provides the illumination for the user sitting in the chair or the like.

### BACKGROUND OF THE INVENTION

1. Field of the Invention

The present invention relates to a sun shield, and more particularly, a sun shield with solar powered light.

2. Description of the Prior Art Numerous innovations for sun shields have been provided in the prior art that will be described. Even though these innovations may be suitable for the specific individual purposes to which they address, however, they differ from the present invention.

A FIRST EXAMPLE, Office Document U.S. Pat. No. 3,162,206, Issued on Dec. 22, 1964, to Betts teaches a sunshade for a chair. The sunshade includes a support frame having a pair of arms interconnected with a base portion, and hanger members swivelly connected to the base portion. The hanger members are adapted to engage the top of the back of the chair. A pair of hook members are pivotally connected to the base portion. Spring apparatus interconnects the hook members. The hook members are adapted to be extended to engage the side edges of the back of the chair, and are further adapted to be retained in an engaged position by the spring apparatus. Further included are an awning frame, a shaft extending through the awning frame and the arms of the support frame, a nut secured to the awning frame, a threaded end portion on the shaft engaging the nut, and a collar freely rotatable on the shaft between the arms of the support frame. Rotation of the shaft in one direction locks the awning frame against the arms of the support frame. Rotation of the shaft in an opposing direction releases the locking engagement of the support and awning frames so as to permit angular adjustment of the awning frame with respect to the support frame.

A SECOND EXAMPLE, Office Document U.S. Pat. No. 4,511,954, Issued on Apr. 16, 1985, to Marcus, et al. teaches an auxiliary visor light including a visor body coupled to a vehicle and including a light housing coupled to the visor body and movable between a stored position substantially flush with the visor body and a use position projecting from the visor body and which is laterally directable to provide selective illumination to the interior of a vehicle.

A THIRD EXAMPLE, Office Document U.S. Pat. No. 4,639,036, Issued on Jan. 27, 1987, to Nichols teaches a sunshade apparatus for a chair or similar structure. The apparatus includes adjustment mechanisms for orienting the canopy sheet with respect to the chair for shade, for use as a tray, or for stowage. The apparatus is attached to the chair with clamping mechanisms that are attached to the legs of a frame member.

A FOURTH EXAMPLE, Office Document U.S. Pat. No. 5,033,528, Issued on Jul. 23, 1991, to Volcani teaches a portable sunshade including a disc having a surface area sufficient for shading a particular portion of a user's body. The disc is supported, at its edge, by a flexible extension that is connected to a rigid extension that, in turn, is connected to a lamp or a suitable supporting device. The flexible section of the extension includes inner-connecting individual units, similar to pop beads, that provide a rotating and bendable gooseneck connection that is lengthenable and/or shortenable or that is connectable directly to the clamp. The clamp clamps the sunshade to a lounge chair or the like allowing the disc to be positioned to shade the user's face.

A FIFTH EXAMPLE, Office Document U.S. Pat. No. 5,331,525, Issued on Jul. 19, 1994, to Lawassani, et al. teaches a primary sun visor that is co-existent with a low profile and thin member, known as a recessed tray, that is independent from the headliner substrate and is thinner than the headliner substrate it replaces. The recessed tray contains an integrally molded center support and outboard bezel area. The primary sun visor vanity mirror lamps are removed and integrated into the recessed tray. The recessed tray retains both the primary and the auxiliary sun visors.

A SIXTH EXAMPLE, Office Document U.S. Pat. No. 5,564,813, Issued on Oct. 15, 1996, to Curtindale teaches a sun visor lamp providing courtesy illumination when the sun visor is in its stowed position.

A SEVENTH EXAMPLE, Office Document U.S. Pat. No. 6,079,683, Issued on Jun. 27, 2000, to Lin teaches an angle-adjustable support for supporting a sunshade device. The support includes a base with a pair of pivot lobes, a retaining member having a coupling portion adapted for coupling with the sunshade device and a retaining projection that is pivoted on the pivot lobes, and an adjusting unit that includes a stationary clamping member disposed below the retaining projection and having a first retaining surface, a movable clamping member disposed below the retaining projecting and having a second retaining surface, and a regulating rod extending threadedly through the movable clamping member, and is coupled rotatably to the stationary clamping member. The regulating rod is operable to move the movable clamping member from a locking position, in which the first and second retaining surfaces engage the peripheral surface of the retaining projection for cooperatively clamping and positioning the retaining projection between the clamping members, and an unlocking position, in which the second retaining surface is moved away from the first retaining surface to release the retaining projection from the clamping members, and to permit pivoting of the retaining member for adjustment of the inclination of the sunshade device.

AN EIGHTH EXAMPLE, Office Document U.S. Pat. No. 6,405,742, Issued on Jun. 18, 2002, to Driscoll teaches a sunshade having an elongated member laterally supported from the end of a pole by a universal joint permitting rotational and angular movement of the member with respect to the longitudinal axis of the pole itself. The pole includes a telescoping arrangement whereby the pole is lengthable or shortable at the discretion of the user. The end of the pole, opposite to its end carrying the member, includes a universal mount connected to a firm anchor or a support by a suitable clamp.

A NINTH EXAMPLE, Office Document U.S. Pat. No. 7,048,333, Issued on May 23, 2006, to Martinez teaches a collapsible sunshade adapted to be used with a chair. The sunshade is made of spring steel or an equivalent material, and is adapted to be affixed to cover the seat portion of a lounge chair. The sunshade is unfolded under the force of a compressed spring, and is attached to the chair to provide shade over the seat of the chair.

A TENTH EXAMPLE, U.S. Patent Office Document No. 2004/0217621, Published on Nov. 4, 2004, to McCoy teaches a sun visor with a flexible arm for shielding sun, glare, vehicle headlights, or other distractions from the eyes of the vehicle's operator. The compact sun visor's shield is attached to a flexible arm allowing for limitless sun visor positioning. The sun visor is permanently mountable or affixable with various clips or adhesives to a motor vehicle, helmet, or any object requiring shading allowing for mounting wherever the operator desires.

AN ELEVENTH EXAMPLE, U.S. Patent Office Document No. 2007/0034342, Published on Feb. 15, 2007, to Fill teaches an adjustable sunshade including an adjustable telescoping rod, an adjustable flexible rod—such as a gooseneck, and a flexible shade. A spike is formed on a lower end of the adjustable telescoping rod for engaging the ground and maintaining the adjustable telescoping rod in a substantially vertical position. The adjustable flexible rod is fixed to the upper end of the telescoping rod, and holds the shade. The height of the sunshade is adjusted by adjusting the telescoping rod. The flexible rod allows positioning of the sunshade over any selected region that a user wishes to shield from sunlight.

A TWELFTH EXAMPLE, U.S. Patent Office Document No. 2007/0215298, Published on Sep. 20, 2007, to Chen teaches a sunshade for a motor vehicle, which is supported by two umbrella structures that are mounted by suction cups on the front windshield and rear window of the vehicle. Locking levers control the suction cups. The telescoping umbrella support structures elevate the sunshade spread out above the vehicle to shade the vehicle interior.

A THIRTEENTH EXAMPLE, U.S. Patent Office Document No. 2008/0088150, Published on Apr. 17, 2008, to Delphia teaches a visor assembly for a vehicle, which includes a visor, a beam, an arm, and a carrier. The beam defines a first path. The arm has a first end and a second end spaced from the first end. The arm moveably supports the visor, with the visor moveable between the first end and the second end of the arm. The carrier supports the arm at the first end. The carrier also connects the beam and the arm with the second end of the arm laterally spaced from a first path defined by the beam. The carrier is moveable along the first path. The visor assembly enables the visor to be manually continuously adjustable in a substantially horizontal, vertical, and angular manner so that the visor can cover a predetermined area of a windshield or a corresponding side window of a vehicle to shade the eyes of an occupant of the vehicle.

It is apparent now that numerous innovations for sun shields have been provided in the prior art that adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a sun shield with solar powered light that avoids the disadvantages of the prior art.

ANOTHER OBJECT of the present invention is to provide a sun shield with solar powered light that is simple and inexpensive to manufacture.

STILL ANOTHER OBJECT of the present invention is to provide a sun shield with solar powered light that is simple to use.

BRIEFLY STATED, STILL YET ANOTHER OBJECT of the present invention is to provide a dual function visor that replaceably attaches to a back of a chair or the like, shields overhead sun from a user sitting in the chair or the like, and provides illumination for the user sitting in the chair or the like. The dual function visor includes a frame and a shade. The frame replaceably attaches to the back of the chair or the like. The shade is pivotally attached to the frame, shields the overhead sun from the user sitting in the chair or the like, and provides the illumination for the user sitting in the chair or the like.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a diagrammatic perspective view illustrating the present invention being utilized as a sun shield;

FIG. 2 is a diagrammatic perspective view illustrating the present invention being utilized as a light source;

FIG. 3 is a diagrammatic perspective view illustrating the present invention per se;

FIG. 4 is an exploded diagrammatic view showing all the components of the present invention disassembled from each other;

FIG. 5 is a diagrammatic plan view showing the present invention with solar cell panel showing;

FIG. 6 is a diagrammatic plan view showing the present invention with light source panel showing;

FIG. 7 is an elevational view taken in the direction of arrow 7 in FIG. 5;

FIG. 8 is an elevational view taken in the direction of arrow 8 in FIG. 5, showing in phantom the device adjusted in other positions;

FIG. 9 is an elevational view taken in the direction of arrow 9 in FIG. 5;

FIG. 10 is an enlarged elevational view a joint component inclosed in the dotted circle indicated by arrow 10 in FIG. 4;

FIG. 11 is an elevational view taken in the direction of arrow 11 in FIG. 10;

FIG. 12 is an enlarged partial cross sectional view taken along line 12-12 in FIG. 5 with parts broken away; and

FIG. 13 is a cross sectional view taken along line 13-13 in FIG. 6.

### A MARSHALING OF REFERENCE NUMERALS UTILIZED IN THE DRAWING

20 dual function visor of embodiments of present invention for replaceably attaching to back 22 of chair or like 24, for shielding overhead sun 26 from user 28 sitting in chair or like 24, and for providing illumination 30 for user 28 sitting in chair or like 24
22 back of chair or like 24
24 chair or like
26 overhead sun
28 user
30 illumination
32 frame for replaceably attaching to back 22 of chair or like 24
34 shade for shielding overhead sun 26 from user 28 sitting in chair or like 24 and for providing illumination 30 for user 28 sitting in chair or like 24
36 pair of arms of frame 32
38 lower portion of each arm of pair of arms 36 of frame 32
40 upper portion of each arm of pair of arms 36 of frame 32
41 lower end of lower portion 38 of each arm of pair of arms 36 of frame 32
42 upper end of upper portion 40 of each arm of pair of arms 36 of frame 32
44 cross piece of frame 32 for replaceably attaching to back 22 of chair or like 24
45 lower connector
45a intermediate connectors
46 headrest of frame 32 for cushioning head of user 28
47 first face of shade 34
48 second face of shade 34
49 light of shade 34 for providing illumination 30 for user 28 sitting in chair or like 24
50 solar cell system of shade 34 for powering light 49 of shade 34
51 upper forced lock pin of each upper connector of upper connectors 45b
52 pair of telescopic tubes of lower portion 38 of each arm of pair of arms 36 of frame 32
54 cooperating pin and axial blind slot of pair of telescopic tubes 52 of lower portion 38 of each arm of pair of arms 36 of frame 32
56 lower forced lock pin of each lower connector of lower connectors
58 clamp of each intermediate connector of intermediate connectors 45a for attaching dual function visor 20 to back 22 of chair or like 24
60 ring of clamp 58 of each intermediate connector of intermediate connectors 45a
62 flange of clamp 58 of each intermediate connector of intermediate connectors 45a
64 pair of cushioned through bores of flange 62 of clamp 58 of each intermediate connector of intermediate connectors 45a
66 screws for attaching clamp 58 of each intermediate connector of intermediate connectors 45a to associated side of pair of sides 68 of back 22 of chair or like 24
68 pair of sides of back 22 of chair or like 24

### DETAILED DESCRIPTION OF THE PREFERRED EMBODIMENT

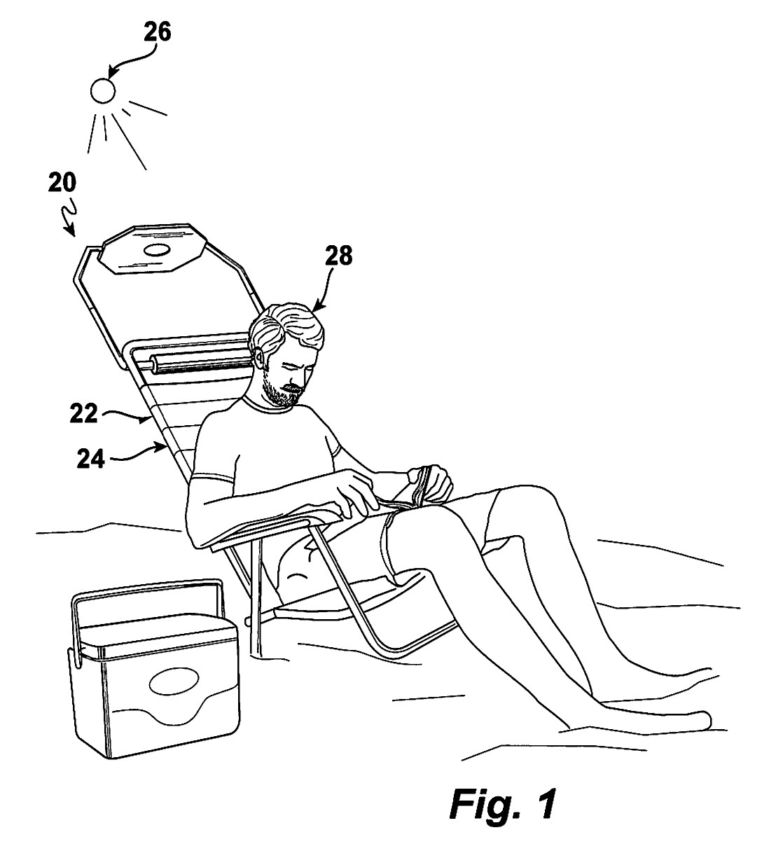

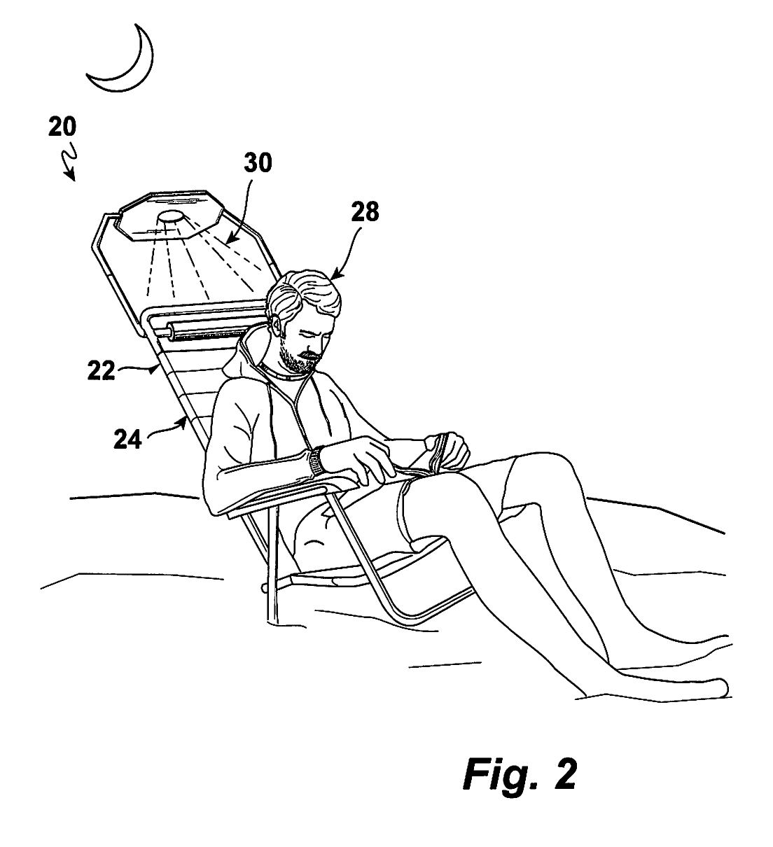

Referring now to the figures, in which like numerals indicate like parts, and particularly to FIGS. 1 and 2, the dual function visor of the embodiments of the present invention is shown generally at 20 for replaceably attaching to a back 22 of a chair or the like 24, for shielding overhead sun 26 from a user 28 sitting in the chair or the like 24 (FIG. 1), and for providing illumination 30 for the user 28 sitting in the chair or the like 24 (FIG. 2).

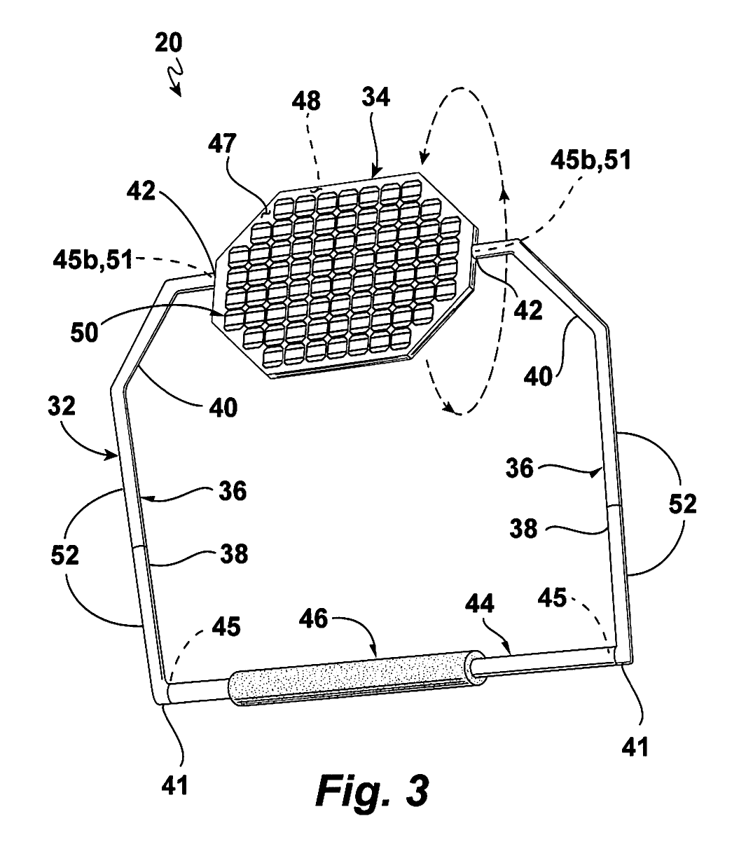

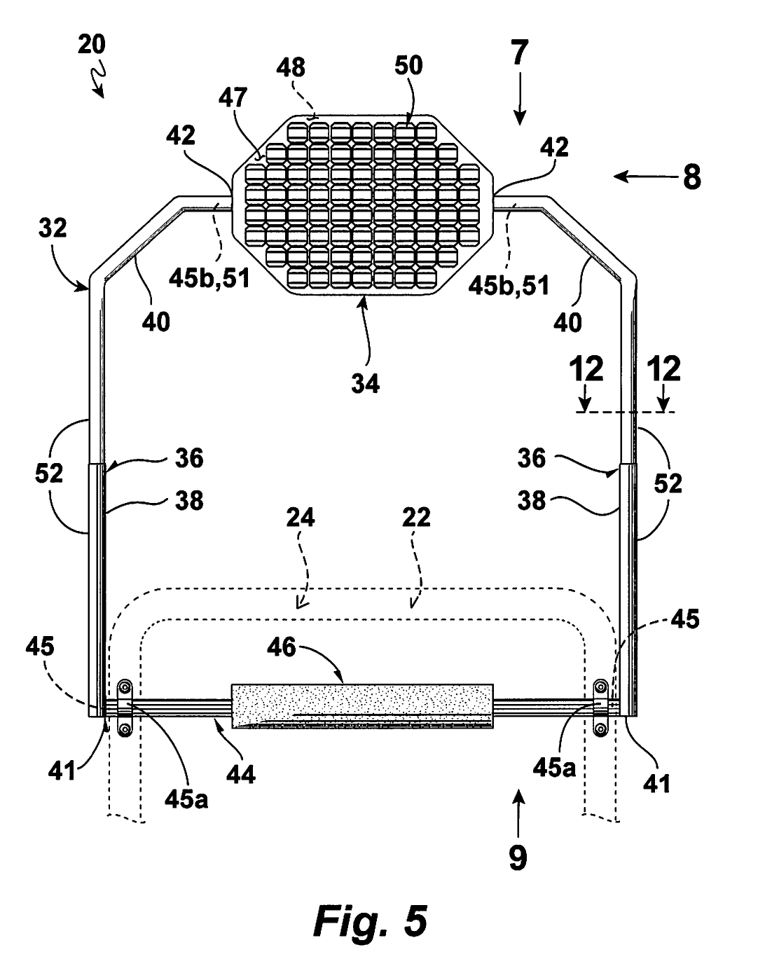

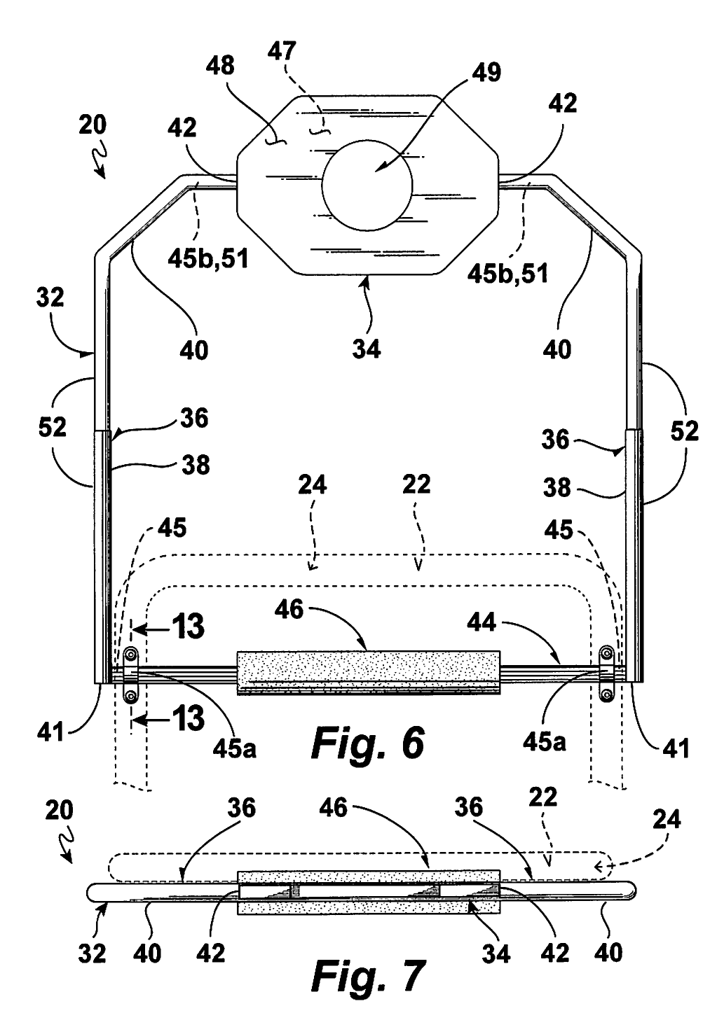

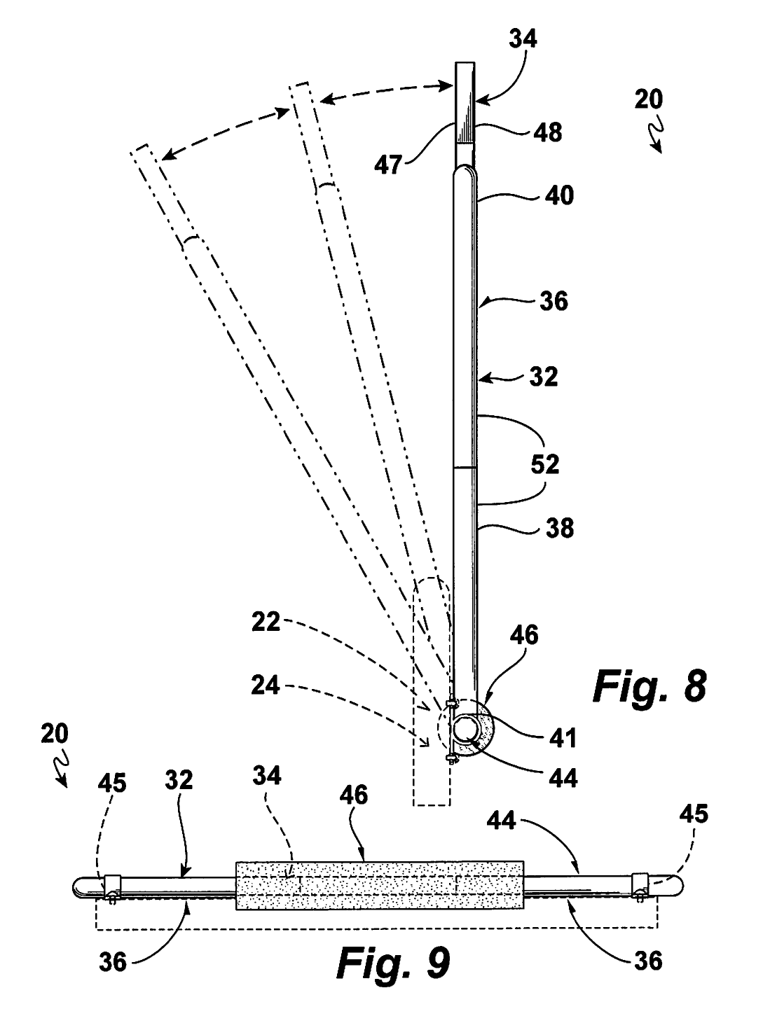

The configuration of the dual function visor 20 can best be seen in FIGS. 3, 4, 5, 6, 7, 8, 9, and 12, and as such, will be discussed with reference thereto.

The dual function visor 20 comprises a frame 32 and a shade 34. The frame 32 is for replaceably attaching to the back 22 of the chair or the like 24. The shade 34 is pivotally attached to the frame 32, and is for shielding the overhead sun 26 from the user 28 sitting in the chair or the like 24, and is further for providing the illumination 30 for the user 28 sitting in the chair or the like 24.

The frame 32 has a height, and comprises a pair of arms 36.

The pair of arms 36 of the frame 32 are mirror images of each other, and oppose each other.

Each arm 36 of the frame 32 is slender, elongated, and tubular, and has a lower portion 38 and an upper portion 40.

The lower portion 38 of each arm 36 of the frame 32 is straight, upwardly oriented, has a lower end 41, and is telescopic to adjust the height of the frame 32.

The upper portion 40 of each arm 36 of the frame 32 is straight, and first extends diagonally inwardly and upwardly from the lower portion 38 of an associated arm 36 of the frame 32, and then extends inwardly to an upper end 42.

The frame 32 further comprises a cross piece 44.

The cross piece 44 of the frame 32 is slender, elongated, horizontally oriented, tubular, replaceably extends by a lower connector 45 from the lower end 41 of the lower portion 38 of one arm 36 of the frame 32 and by another lower connector 45 to the lower end 41 of the lower portion 38 of the other arm 36 of the frame 32, and is for replaceably attaching to the back 22 of the chair or the like 24 by intermediate connectors 45a.

The shade 34 pivotally and replaceably receives the upper end 42 of the upper portion 40 of each arm 36 of the frame 32 by upper connectors 45b.

The frame 32 further comprises a headrest 46.

The headrest 46 of the frame 32 is slender, elongated, horizontally oriented, tubular, collinearly and replaceably receives the cross piece 44 of the frame 32 to facilitate replacement of the headrest 46 of the frame 32 when the headrest 46 of the frame 32 becomes soiled from the head of the user 28, and is made of foam for cushioning the head of the user 28.

The shade 34 is flat, thin, hexagonally shaped, and has a first face 47 and a second face 48.

The first face 47 of the shade 34 is opposite to the second face 48 of the shade 34.

The shade 34 further comprises a light 49.

The light 49 of the shade 34 is disposed on the second face 48 of the shade 34, and is for providing the illumination 30 for the user 28 sitting in the chair or the like 24 when the shade 34 is pivoted to have the second face 48 of the shade 34 face the user 28 sitting in the chair or the like 24.

The shade 34 further comprises a solar cell system 50.

The solar cell system 50 of the shade 34 is disposed on the first face 47 of the shade 34, is in electrical communication with the light 49 of the shade 34, and is for powering the light 49 of the shade 34 when the shade 34 is pivoted to have the first face 47 of the shade 34 face the sun.

Each upper connector 45b comprises an upper forced lock pin 51.

The upper forced lock pin 51 of each upper connector 45b extends outwardly from opposite sides of the shade 34, and is pivotally and replaceably received by the upper end 42 of the upper portion 40 of an associated arm 36 of the frame 32 so as to allow the shade 34 to be pivoted.

The lower portion 38 of each arm 36 of the frame 32 comprises a pair of telescopic tubes 52 so as to allow adjustment of the height of the frame 32.

As shown in FIG. 12, the pair of telescopic tubes 52 of the lower portion 38 of each arm 36 of the frame 32 are prevented from relative rotation therebetween by a cooperating pin and axial blind slot 54.

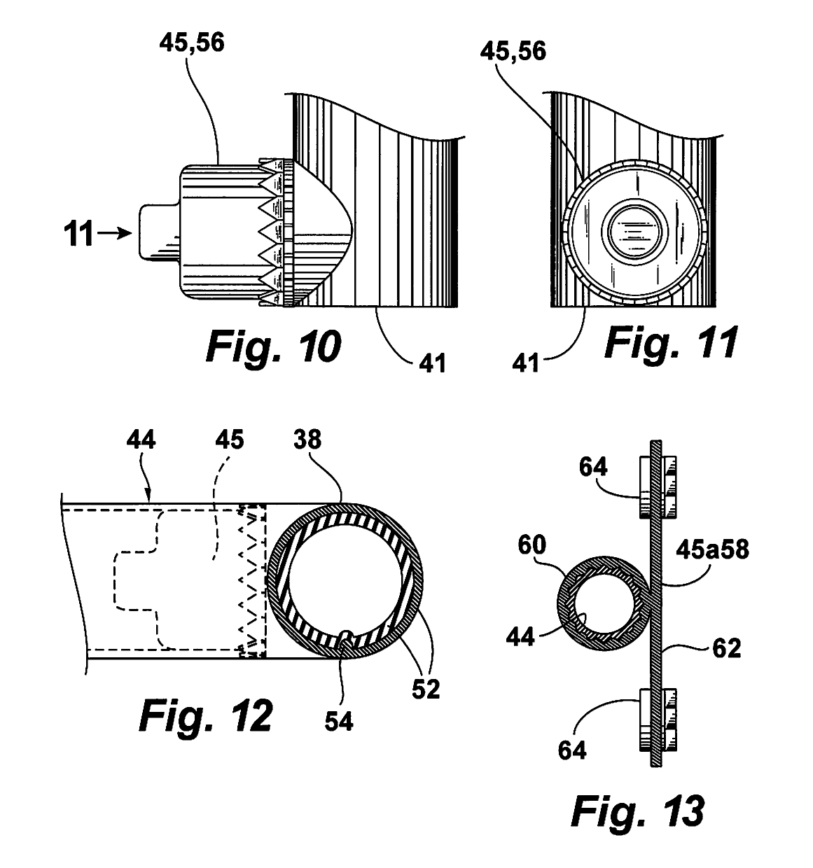

The configuration of each lower connector 45 can best be seen in FIGS. 10 and 11, and as such, will be discussed with reference thereto.

Each lower connector 45 comprises a lower forced lock pin 56.

The lower forced lock pin 56 of each lower connector extends inwardly from the lower end 41 of the lower portion 38 of an associated arm 36 of the frame 32, and is received by the cross piece 44 of the frame 32.

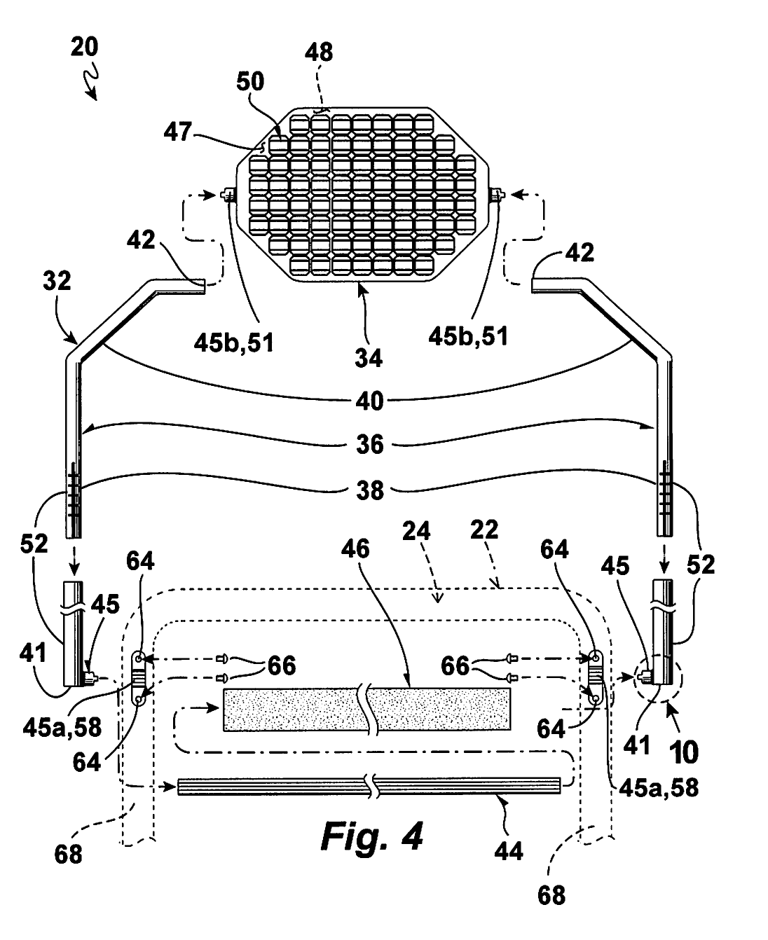

The configuration of each intermediate connector 45a can best be seen in FIGS. 4 and 13, and as such, will be discussed with reference thereto.

Each intermediate connector 45a comprises a clamp 58. The clamp 58 of each intermediate connector 45a is for attaching the dual function visor 20 to the back 22 of the chair or the like 24.

The clamp 58 of each intermediate connector 45a comprises a ring 60 and a flange 62.

The ring 60 of the clamp 58 of each intermediate connector 45a extends outwardly from the flange 62 of the clamp 58 of an associated intermediate connector 45a, and receives the cross piece 44 of the frame 32.

The flange 62 of the clamp 58 of each intermediate connector 45a has a pair of cushioned through bores 64. The pair of cushioned through bores 64 of the flange 62 of the clamp 58 of each intermediate connector 45a are for preventing damage to the back 22 of the chair or the like 24 when the clamp 58 of each intermediate connector 45a is attached thereto.

The pair of cushioned through bores 64 of the flange 62 of the clamp 58 of each intermediate connector 45a straddle the ring 60 of the clamp 58 of an associated intermediate connector 45a, and receive screws 66. The screws 66 are for attaching the clamp 58 of each intermediate connector 45a to an associated side 68 of the back 22 of the chair or the like 24.

It will be understood that each of the elements described above, or two or more together, may also find a useful application in other types of constructions differing from the types described above.

While the invention has been illustrated and described as embodiments of a sun shield with solar powered light, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A dual function visor for replaceably attaching to a back of a chair, for shielding overhead sun from a user sitting in the chair, and for providing illumination for the user sitting in the chair, said dual function visor comprising:
a) a frame; and
b) a shade;
wherein said frame is for replaceably attaching to the back of the chair;
wherein said shade is pivotally attached to the frame;
wherein said shade is for shielding the overhead sun from the user sitting in the chair; and
wherein said shade is for providing the illumination for the user sitting in the chair.

2. The dual function visor of claim 1, wherein said frame comprises a pair of arms.

3. The dual function visor of claim 2, wherein said pair of arms of said frame are mirror images of each other.

4. The dual function visor of claim 2, wherein said pair of arms of said frame oppose each other.

5. The dual function visor of claim 2, wherein each arm of said frame is slender.

6. The dual function visor of claim 2, wherein each arm of said frame is elongated.

7. The dual function visor of claim 2, wherein each arm of said frame is tubular.

8. The dual function visor of claim 2, wherein each arm of said frame has a lower portion.

9. The dual function visor of claim 8, wherein each arm of said frame has an upper portion.

10. The dual function visor of claim 8, wherein said lower portion of each arm of said frame is straight.

11. The dual function visor of claim 8, wherein said lower portion of each arm of said frame is upwardly oriented.

12. The dual function visor of claim 8, wherein said lower portion of each arm of said frame has a lower end.

13. The dual function visor of claim 9, wherein said upper portion of each arm of said frame is straight.

14. The dual function visor of claim 9, wherein said upper portion of each arm of said frame first extends diagonally inwardly and upwardly from said lower portion of an associated arm of said frame, and then extends inwardly to an upper end.

15. The dual function visor of claim 8, wherein said frame has a height; and
wherein said lower portion of each arm of said frame is telescopic to adjust said height of said frame.

16. The dual function visor of claim 12, wherein said frame comprises a cross piece; and
wherein said cross piece of said frame is for replaceably attaching to the back of the chair by intermediate connectors.

17. The dual function visor of claim 16, wherein said cross piece of said frame is slender.

18. The dual function visor of claim 16, wherein said cross piece of said frame is elongated.

19. The dual function visor of claim 16, wherein said cross piece of said frame is horizontally oriented.

20. The dual function visor of claim 16, wherein said cross piece of said frame replaceably extends by a lower connector from said lower end of said lower portion of one arm of said frame and by another lower connector to said lower end of said lower portion of the other arm of said frame.

21. The dual function visor of claim 14, wherein said shade pivotally receives said upper end of said upper portion of each arm of said frame.

22. The dual function visor of claim 14, wherein said shade replaceably receives said upper end of said upper portion of each arm of said frame by upper connectors.

23. The dual function visor of claim 16, wherein said frame comprises a headrest.

24. The dual function visor of claim 23, wherein said headrest of said frame is slender.

25. The dual function visor of claim 23, wherein said headrest of said frame is elongated.

26. The dual function visor of claim 23, wherein said headrest of said frame is horizontally oriented.

27. The dual function visor of claim 23, wherein said headrest of said frame collinearly receives said cross piece of said frame.

28. The dual function visor of claim 23, wherein said headrest of said frame replaceably receives said cross piece of said frame to facilitate replacement of said headrest of said frame when said headrest of said frame becomes soiled from the head of the user.

29. The dual function visor of claim 23, wherein said headrest of said frame is made of foam for cushioning the head of the user.

30. The dual function visor of claim 1, wherein said shade is flat.

31. The dual function visor of claim 1, wherein said shade is thin.

32. The dual function visor of claim 1, wherein said shade is hexagonally shaped.

33. The dual function visor of claim 1, wherein said shade has a first face.

34. The dual function visor of claim 33, wherein said shade has a second face.

35. The dual function visor of claim 34, wherein said first face of said shade is opposite to said second face of said shade.

36. The dual function visor of claim 34, wherein said shade comprises a light.

37. The dual function visor of claim 36, wherein said light of said shade is disposed on said second face of said shade; and
wherein said light of said shade is for providing the illumination for the user sitting in the chair when said shade is pivoted to have said second face face the user sitting in the chair.

38. The dual function visor of claim 36, wherein said shade comprises a solar cell system.

39. The dual function visor of claim 38, wherein said solar cell system of said shade is disposed on said first face of said shade.

40. The dual function visor of claim 38, wherein said solar cell system of said shade is in electrical communication with said light of said shade; and
wherein said solar cell system of said shade is for powering said light of said shade when said shade is pivoted to have said first face of said shade face the sun.

41. The dual function visor of claim 22, wherein each upper connector comprises an upper forced lock pin.

42. The dual function visor of claim 41, wherein said upper forced lock pin of each upper connector extends outwardly from opposite sides of said shade.

43. The dual function visor of claim 41, wherein said upper forced lock pin of each upper connector is pivotally received by said upper end of said upper portion of an associated arm of said frame so as to allow sais shade to be pivoted.

44. The dual function visor of claim 41, wherein said upper forced lock pin of each upper connector is replaceably received by said upper end of said upper portion of an associated arm of said frame.

45. The dual function visor of claim 8, wherein said lower portion of each arm of said frame comprises a pair of telescopic tubes so as to allow adjustment of said height of said frame.

46. The dual function visor of claim 45, wherein said pair of telescopic tubes of said lower portion of each arm of said frame are prevented from relative rotation therebetween by a cooperating pin and axial blind slot.

47. The dual function visor of claim 20, wherein each lower connector comprises a lower forced lock pin.

48. The dual function visor of claim 47, wherein said lower forced lock pin of each lower connector extends inwardly from said lower end of said lower portion of an associated arm of said frame.

49. The dual function visor of claim 47, wherein said lower forced lock pin of each lower connector is received by said cross piece of said frame.

50. The dual function visor of claim 16, wherein each intermediate connector comprises a clamp.

51. The dual function visor of claim 50, wherein said clamp of each intermediate connector comprises a ring.

52. The dual function visor of claim 51, wherein said clamp of each intermediate connector comprises a flange.

53. The dual function visor of claim 52, wherein said ring of said clamp of each intermediate connector extends outwardly from said flange of said clamp of an associated intermediate connector.

54. The dual function visor of claim 51, wherein said ring of said clamp of each intermediate connector receives said cross piece of said frame.

55. The dual function visor of claim 52, wherein said flange of said clamp of each intermediate connector has a pair of cushioned through bores; and
wherein said pair of cushioned through bores of said flange of said clamp of each intermediate connector are for preventing damage to the back of the chair when said clamp of each intermediate connector is attached thereto.

56. The dual function visor of claim 55, wherein said pair of cushioned through bores of said flange of said clamp of each intermediate connector straddle said ring of said clamp of an associated intermediate connector.

57. The dual function visor of claim 55, wherein said pair of cushioned through bores of said flange of said clamp of each intermediate connector receive screws; and
wherein said screws are for attaching said clamp of each intermediate connector to an associated side of the back of the chair.
